(19) United States
(12) Patent Application Publication
(10) Pub. No.: US 2009/0034832 A1
(43) Pub. Date: Feb. 5, 2009

(54) Device and method for scanning the whole surface of a wafer

(75) Inventors: Wolfgang Vollrath, Burbach (DE); Alexander Buettner, Wetzlar (DE); Christof Krampe-Zadler, Castrop-Rauxel (DE)

Correspondence Address: Davidson, Davidson & Kappel, LLC, 485 7th Avenue, 14th Floor, New York, NY, 10018, US

(73) Assignee: VISTEC Semiconductor Systems GmbH, Weilburg (DE)

(21) Appl. No.: 12/220,532

(22) Filed: Jul. 25, 2008

(30) Foreign Application Priority Data
Aug. 3, 2007 (DE) DE 102007036811.0

(51) Int. Cl. G06K 9/00

(52) U.S. Cl. 382/145

(57) ABSTRACT

A device and a method for scanning the whole surface of a wafer are disclosed. The wafer is deposited on a table movable in the X-coordinate direction and in the Y-coordinate direction. A camera and at least one illumination source are arranged opposite the wafer. The camera is a line camera with a detector row, wherein the length of the detector row is less than the diameter of the wafer.

This claims the benefit of German Patent Application No. 10 2007 036 811.0, filed on Aug. 3, 2007 and hereby incorporated by reference herein.

The present invention relates to a device for scanning the whole surface of a wafer. The wafer itself is deposited on a table movable in the X-coordinate direction and in the Y-coordinate direction. At least one illumination source is arranged opposite the wafer. There is also provided a means for generating a relative movement between the camera and the wafer.

The invention further relates to a method for scanning the whole surface of a wafer.

### BACKGROUND

German patent application DE 102005047279.6 discloses a device for capturing an image of at least one surface of a disk-shaped object of the semiconductor industry. The device includes a camera, a scanning system and a deflecting means. The camera and the disk-shaped object are stationary relative to each other. The scanning system is mounted to be movable at least along the whole surface of the disk-shaped object with a first speed. The deflecting system directing light from the scanning system to the camera is also movable along the surface of the disk-shaped object with the second speed. The two speeds are parallel and unidirectional. The scanning system may capture the whole surface of the disk-shaped object of the semiconductor industry in one moving step.

U.S. Pat. No. 5,818,576 discloses a device for inspecting the surface of a wafer carrying the structures. The light returning from the surface of the wafer is imaged onto a CCD line. With one movement of the X/Y table, the whole surface of the wafer may be scanned.

U.S. Pat. No. 6,512,843 also discloses image acquisition of the surface of a wafer by a TDI camera. A meander scan is used to scan the whole surface of the wafer.

U.S. Pat. No. 5,644,393 discloses a device for inspecting the surface of a substrate. Three cameras of identical construction are used to achieve quick inspection of the whole surface.

German patent document DE 1057244.1 B4 discloses a method for the defect analysis of wafers. The image data of the wafer are acquired by means of a flat-bed scanner. The image data are thus acquired in a single scanning movement of the scanning means of the flat-bed scanner. The image data are then transmitted to an image processing unit.

### SUMMARY OF THE INVENTION

An object of the invention is to provide a device that allows capturing a structured wafer surface with maximum speed and resolution.

The present invention provides a device including a table movable in a X-coordinate direction and in a Y-coordinate direction on which the wafer is positioned. At least one illumination source is arranged opposite the wafer. A means for generating a relative movement between at least two cameras and the wafer is provided, wherein the first camera is a line camera with at least one detector row, which is implemented as a time-delayed integration camera, wherein the length of the at least one detector row is less than the diameter of the wafer, and wherein the second camera is a color camera.

It is further additional or alternative object of the invention to provide a method that allows capturing a structured wafer surface with maximum speed and resolution.

The present invention provides a method for scanning the whole surface of a wafer. At first the depositing of the wafer on a table movable in a X-coordinate direction and in a Y-coordinate direction is carried out. At least a first camera, a second camera and at least one illumination source is arranged opposite to the wafer. A relative movement between the first and the second camera and the wafer is generated. The first camera is a line camera with at least one detector row, which is implemented as a time-delayed integration camera, wherein the length of the detector row is less than the diameter of the wafer, wherein the whole surface of the wafer is scanned by a meander scan and wherein the second camera is implemented as a color camera.

The inventive device allows scanning the whole surface of a wafer. The scan of the whole surface of the wafer is performed quickly and with a high resolution. The wafer itself is deposited on a table movable in the X-coordinate direction and in the Y-coordinate direction. At least one illumination source is arranged opposite the wafer. There is further provided a means for generating a relative movement between at least one camera and the wafer. At least two cameras are provided, wherein a first camera is a line camera having at least one detector row. This camera is implemented as a time-delayed integration camera, wherein the length of the at least one detector row is less than the diameter of the wafer, and wherein a second camera is a color camera.

The means for generating the relative movement may be designed such that only the camera is moved by it. It is also contemplated that the means for generating the relative movement only moves the table. The relative movement is designed such that the whole surface of the wafer is scanned by the camera in the form of a meander.

The inventive method for scanning the whole surface of a wafer is characterized in that first the wafer is deposited on a table movable in the X-coordinate direction and in the Y-coordinate direction. At least one camera and at least one illumination source are arranged opposite the wafer. A relative movement is generated between the camera and the wafer. The camera is implemented as a line camera and includes a detector row whose length is less than the diameter of the wafer. Thus the whole surface of the wafer is scanned by means of a meander scan.

### BRIEF DESCRIPTION OF THE DRAWINGS

In the following, embodiments will explain the invention and its advantages in more detail with reference to the accompanying figures, in which:

FIG. 1 schematically shows a device with which the whole surface of a wafer is captured quickly and with high resolution;

FIG. 2 shows a representation of the scanning of the surface of a wafer;

FIG. 3 shows a schematic representation and an explanation of the operation of a TDI detector; and

FIG. 4 shows a schematic representation of an area sensor with which different colors of the detection light are detected.

### DETAILED DESCRIPTION

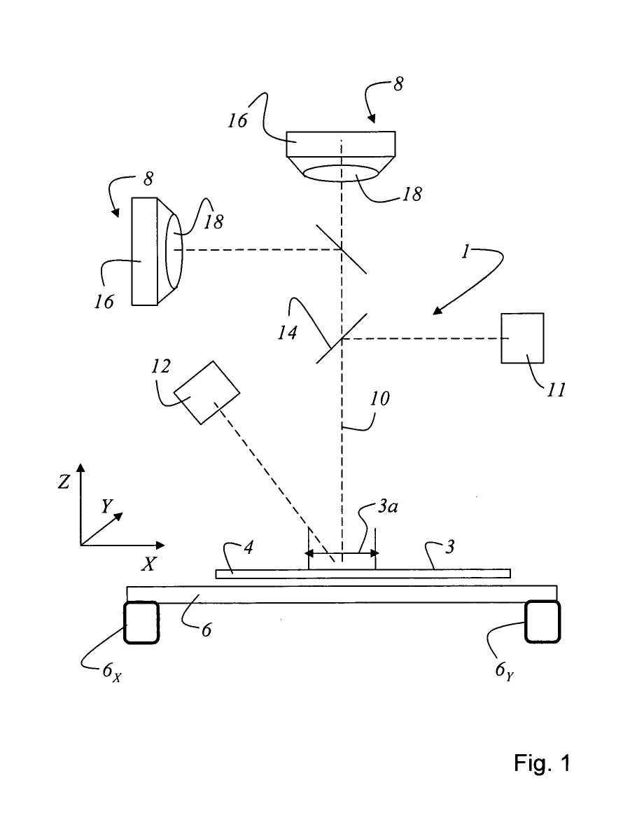

The device 1 for capturing the whole surface 3 of a wafer 4 is illustrated in FIG. 1. The wafer 4 itself is deposited on a table 6 designed to be movable in the X-coordinate direction and in the Y-coordinate direction by means 6_{X} for generating a movement in the X-coordinate direction and by means 6_{Y} for generating a movement in the Y-coordinate direction. Opposite the surface 3 of the wafer 4, a camera 8 is provided which acquires an image of each portion 3a of the surface 3 of the wafer 4. The camera 8 is arranged in an optical axis 10. In the embodiment shown in FIG. 1, the device 1 for capturing the surface of a wafer is provided with a first illumination means 11 and a second illumination means 12. The first illumination means 11 is arranged in the bright field arrangement. The light of the first illumination means 11 is provided in the optical axis 10 by means of a beam splitter 14, the second illumination means 12 is arranged in the dark field arrangement. The first illumination means 11 and the second illumination means 12 are advantageously implemented as permanent light sources. The use of a permanent light source is further advantageous in that there is a large variety of illumination sources available from which to choose the illumination source suitable for the device. One of the cameras 8 itself can be implemented as a line camera and includes a detector row 16 and optics 18 upstream to the detector row 16, and the other camera 8 can be implemented as a color camera.

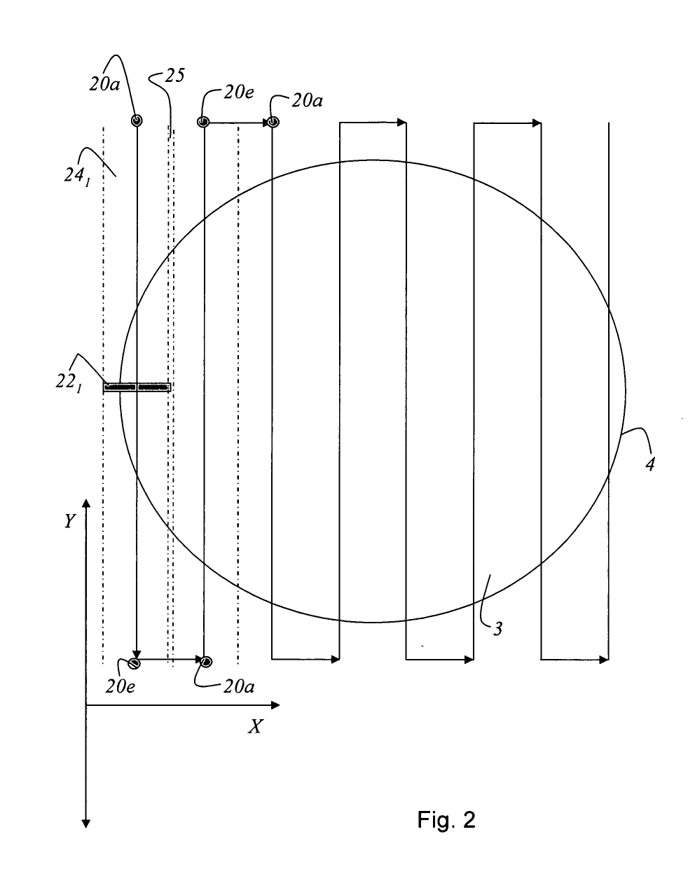

FIG. 2 shows a top view of the surface 3 of a wafer 4. It shows the method with which the whole surface 3 of the wafer 4 is scanned. Since the scan line 16 of the camera 8 is smaller than the diameter of the wafer 4, a so-called meander scan must be performed for scanning the whole surface 3 of the wafer 4. The scan line images an area 3a. This area 3a is moved across the surface 3 of the wafer in accordance with a meander such that the whole surface is scanned. Starting from a start position 20, either the camera 8 or the table 6 on which the wafer is located is moved in the Y-direction. The capturing line 22 of the camera 8 sweeps a rectangular area 24₁. The table 6 is moved in the Y-coordinate direction until the capturing line 22 has reached the end point 20e. At the end point 20e, the movement of the table 6 in the Y-coordinate direction is stopped. There is then a translation of the table 6 or of the camera 8 in the X-coordinate direction at the end point 20e. The translation in the X-coordinate direction does not exceed the width of the capturing line 22. It is clear to someone skilled in the art that the translation in the x-coordinate direction may also be slightly smaller than the length of the capturing line 22. In this case, the result is a small overlapping area 25 due to which the surface of the wafer 4 is scanned twice. Once during the movement of the capturing line in the Y-coordinate direction and once during the movement of the scan line in the opposite direction after the capturing line 22 was offset in the X-direction by the translation. By scanning a small area of the surface 3 of the wafer 4 twice, the individual acquired images may afterwards be combined more easily to form a complete image of the surface 3 of the wafer.

After the translation of the table or the camera in the X-coordinate direction, another relative movement in the Y-coordinate direction is performed starting from the new starting point 20a. The movement in the Y-coordinate direction may be performed solely by a translational movement of the table in the Y-coordinate direction. It is also contemplated that the movement of the capturing line 22 is performed solely by a movement of the camera 8 in the Y-coordinate direction. When the capturing line 22 has reached the new end point 20e, there is another translation in the X-coordinate direction starting from this point in order to displace the capturing line 22 to a new starting point 20a. This movement pattern is continued until the whole surface 3 of the wafer 4 has been covered.

Since the diameter of the wafers has been steadily increasing and has currently reached a diameter of 300 nm, it is no longer possible to scan a wafer of this diameter with a resolution smaller than or equal to 30 μm of the whole wafer width or the whole wafer diameter with a single line camera. As described in FIG. 2, in that case a line camera has to be taken across the surface 3 of the wafer in a meander scan. With this scan, images of the front or back of the wafer may be acquired, for example. In the meander scan described in FIG. 2, only part of the wafer is captured during each movement in one direction. After displacing the camera perpendicularly to the scanning direction by about one object field width (width of the capturing line), the capturing line is then moved in a direction opposite to the first capturing direction. As described in FIG. 2, this continues until the whole surface 3 of the wafer has been scanned. Previously, area cameras were used for this purpose. The disadvantage of using area cameras is the scalability of the optical resolution while, at the same time, a high throughput is obtained. This problem is reduced or eliminated by the present invention. As described in FIG. 2, the whole surface of the wafer is scanned line by line by a line camera. The use of a TDI camera is particularly advantageous. This camera needs an exposure time 30 times shorter than for conventional line cameras. Furthermore, a continuous light source may be used for the illumination of the surface of the wafer.

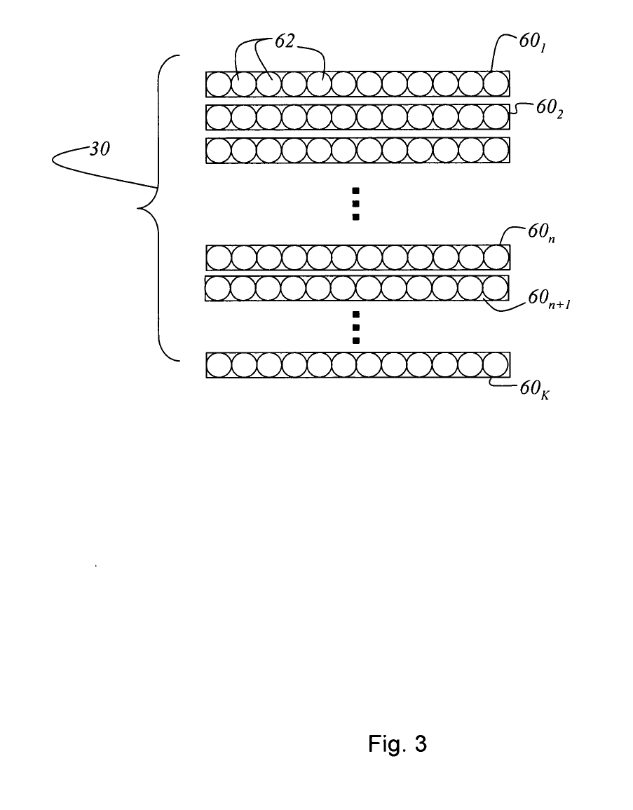

FIG. 3 describes an embodiment of a detector with which the data of the area of the wafer 4 scanned by the meander scan are recorded. One possible implementation of a detector is a TDI detector 30. This detector type is a line detector with time-delayed integration (TDI) technology thus resulting in a photosensitivity in the embodiment described that is K times higher than in conventional line cameras. Particularly for dim objects, significantly higher measuring and scanning speeds may be achieved with a TDI camera (for example, wafer inspection with dark field illumination). On the other hand, TDI cameras need less light for the same speed. The use of TDI cameras requires the movement (relative movement) of the wafer 3 in a preferred direction. As can be seen from FIG. 2, the preferred direction in the present case is the Y-coordinate direction. This movement is performed with a defined speed. The TDI principle is based on the time-delayed multiple exposure of the moved wafer 3. During the movement of the wafer, the charges are shifted from one CCD line 60ₙ to the next CCD line 60ₙ₊₁ and summed up. The charges are summed up in the individual CCD pixels 62. Synchronization of transport speed and exposure time is necessary. If the wafer 3 is exposed at the time T in the CCD line 60ₙ, the same object point must have reached the CCD line 60ₙ₊₁ after exactly one exposure period. If the CCD chip has, for example, K lines, the image point is exposed K times.

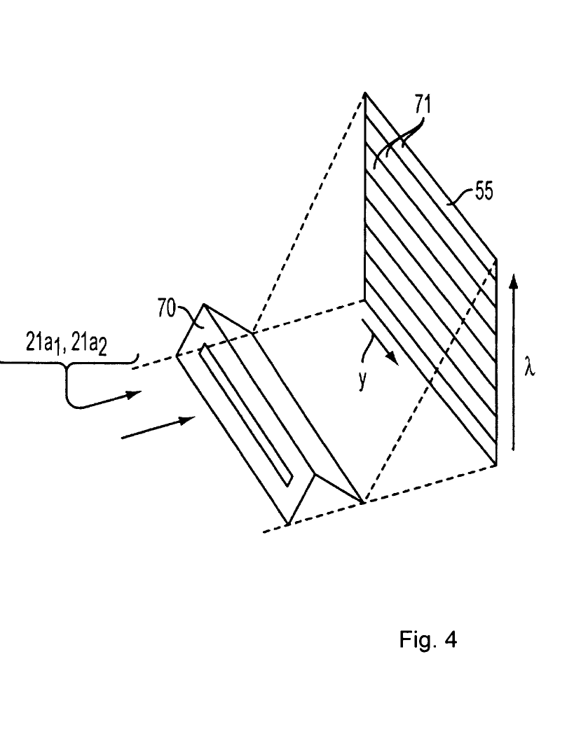

FIG. 4 describes an embodiment of a camera with which the color data of the area of the wafer scanned by the meander scan are recorded. FIG. 4 shows the embodiment of the detector means 21₁ and/or 21₂, wherein the detector means includes a two-dimensional detector chip 55. For this purpose, a dispersive element 70 is arranged in the second optical detection path 21a₁ or 21a₂. The dispersive element 70 serves for spatially separating the spectral components of the detection light in the optical detection path 21a₁ or 21a₂ so that the detection light may be imaged in a spectrally divided manner onto the detector rows 71 of the detector chip 55. A lens (not shown) is arranged downstream to the dispersive element 70 and correspondingly images the spatially divided light suitably onto the detector rows 71 of the two-dimensional detector chip 55. The embodiment shown here obtains an imaging spectrometer.

The invention has been described with reference to the preferred embodiment. However, it is clear for someone skilled in the art that variations and modifications may be made without departing from the scope of the following claims.

What is claimed is:

1. A device for scanning a whole surface of a wafer, comprising:
a table movable in a X-coordinate direction and in a Y-coordinate direction on which the wafer is positioned;
at least one illumination source arranged opposite the wafer;
at least two cameras including a first camera and a second camera; and
means for generating a relative movement between the at least two cameras and the wafer, wherein the first camera is a line camera with at least one detector row, the first camera being implemented as a time-delayed integration camera, wherein a length of the at least one detector row is less than the diameter of the wafer, and wherein the second camera is a color camera.

2. The device of claim 1, wherein the means for generating a relative movement only moves the table.

3. The device of claim 1, wherein the relative movement has the shape of a meander designed such that the whole surface of the wafer is scanned by the cameras.

4. The device of claim 1, wherein the second camera is a color line camera.

5. The device of claim 4, wherein the second camera comprises a two-dimensional detector chip with a dispersive element upstream thereto.

6. The device of claim 1, wherein the at least one illumination source is a permanent light source.

7. The device of claim 6, wherein at least a first illumination source is arranged in the bright field arrangement and that at least a second illumination source is arranged in the dark field arrangement.

8. A method for scanning the whole surface of a wafer, comprising the steps of:
depositing the wafer on a table movable in a X-coordinate direction and in a Y-coordinate direction;
arranging at least a first camera, a second camera and at least one illumination source opposite the wafer;
generating a relative movement between the first and the second camera and the wafer;
wherein the first camera is a line camera with at least one detector row, which is implemented as a time-delayed integration camera, wherein the length of the detector row is less than the diameter of the wafer, wherein the whole surface of the wafer is scanned by a meander scan; and wherein the second camera is implemented as a color camera.

9. The method of claim 8, wherein one of the cameras is a color line camera.

10. The method of claim 8, wherein the second camera comprises a two-dimensional detector chip with which a dispersive element is associated upstream to the detector chip of the camera.

11. The method of claims 8, wherein a permanent light source is provided as illumination source.

12. The method of claim 9, wherein at least a first illumination source is arranged in the bright field arrangement, and that at least a second illumination source is arranged in the dark field arrangement.

13. A device for scanning a whole surface of a wafer, comprising:
a table movable in a X-coordinate direction and in a Y-coordinate direction on which the wafer is positioned;
at least one illumination source arranged opposite the wafer;
at least two cameras including a first camera and a second camera; and
a device generating a relative movement between the at least two cameras and the wafer, wherein the first camera is a line camera with at least one detector row, the first camera being implemented as a time-delayed integration camera, wherein a length of the at least one detector row is less than the diameter of the wafer, and wherein the second camera is a color camera.
